(19) United States
(12) Patent Application Publication
(10) Pub. No.: US 2008/0146190 A1
(43) Pub. Date: Jun. 19, 2008

(54) Method and System for Displaying a Set of Entries

(75) Inventor: Thomas F. Kister, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/610,297

(22) Filed: Dec. 13, 2006

(51) Int. Cl. H04M 11/00; G06K 9/00

(52) U.S. Cl. 455/405; 382/117

(57) ABSTRACT

A method (200) for compiling and presenting an ordered list for each of the available options for a communication device is disclosed. The method includes monitoring a frequency of employment of available options by a user of the communication device (100). Further, the method (200) includes dynamically compiling a list for each of the available options. The list is ordered from the most frequently employed to the least frequently employed. Furthermore, the method (200) includes presenting the ordered list for access by the user of the communicating device.

### FIELD OF THE INVENTION

This invention generally relates to communication devices, and more particularly, to displaying a set of entries stored in a communication device.

### BACKGROUND OF THE INVENTION

Nowadays, communication devices such as a fixed line phone, a videophone, a computer, and a mobile phone can store a number of entries, in addition to facilitating communication. Examples of an entry include an electronic mail (email) address, a residential address, a contact number such as telephone, mobile no and the like. The stored entries can be displayed on an output unit, such as a Liquid Crystal Display (LCD) screen, a Thin Film Transistor (TFT) screen, a plasma screen, of a communication device. Usually the stored entries are sorted in an alphabetical order, for example, a phone-book in a mobile phone is arranged in an alphabetical order. When a user of the communication device needs to look-up for a specific entry, he/she may have to scroll down through a number of entries, before reaching the specific entry. This is a time consuming and inconvenient process and becomes even more undesirable, when the specific entry (or a contact number) is to be frequently accessed (or dialed).

In the light from the above discussion, there exists a need for a method and system for displaying a set of entries in order of frequency of usage. Further, the method should ensure ease in locating a particular entry from the stored entries in a communication device. Moreover, the frequently accessed entries should conveniently accessible by a user.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary communication device, in accordance with an embodiment of the present invention;

FIG. 2 is a flow diagram illustrating a method for compiling and presenting an ordered list of available options for a communication device, in accordance with an embodiment of the present invention;

FIG. 3 is a block diagram of a communication device, in accordance with an embodiment of the present invention; and

FIG. 4 is a flow diagram illustrating a method for compiling and presenting an ordered list of user available options, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for displaying a set of entries in accordance with various embodiment of the present invention, it should be observed that the present invention utilizes a combination of method steps and apparatus components related to the method and system for displaying a set of entries stored in communication devices. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element.

A “set”, as used in this document, means a non-empty set, i.e., comprising at least one member. The term “another,” as used in this document, is defined as at least a second or more. The terms “includes” and/or “having”, as used herein, are defined as comprising.

In one embodiment, a method for compiling and presenting an ordered list of available options for a communication device is provided. The method includes monitoring a frequency, with which a user of the communication device employs the available options. Further, the method includes dynamically compiling a list for each of the available options by ordering the list from the most frequently employed to the least frequently employed. Moreover, the method includes presenting the ordered list to be accessed by the user.

In another embodiment, a communication device to compile and present an ordered list of available options is provided. The communication device includes a user interface to employ the available options. The communication device also includes a processor to monitor the frequency, with which a user of the communication device employs the user interface to access the available options. Further, the communication device also includes a memory means for storing a dynamically compiled listing of the available options The dynamically compiled listing of the available options is ordered from the most frequently employed to the least frequently employed available option. Moreover, the communication device also includes an output means for displaying the ordered list of available options to the user of the communication device.

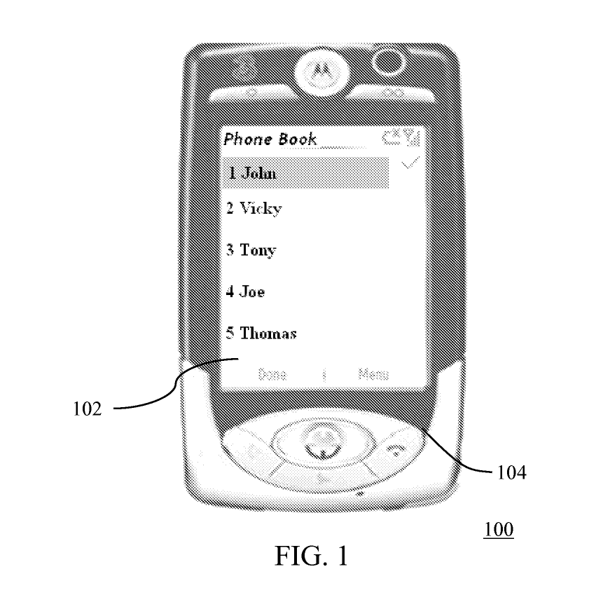

FIG. 1 illustrates an exemplary communication device 100, in accordance with an embodiment of the present invention. It should be noted that the communication device 100 is shown as a mobile phone for the sake of clarity, however, it will be apparent to a person ordinarily skilled in the art that the invention can be implemented in any other electronic device as well such as a videophone, a portable media player, a fixed line phone, a cordless phone, and a voice over internet protocol (VoIP) phone.

The communication device 100 includes a display screen 102, and a user interface 104. The display screen 102 can be a Liquid Crystal Display (LCD) screen, a Thin Film Transistor (TFT) screen, a plasma screen, and the like. The display screen 102 enables display of various information such as, a phone book listing, a list of available options, the time duration of a call, a text message, a picture message, a caller identification (ID), and the like. For example the FIG. 1 shows a LCD screen, displaying a phone book of a mobile phone. Further, the user interface 104 allows a user to utilize various functions of the communication device 100 by accepting the user-input. Examples of a user interface can be a keypad, a joystick, a touch screen, a display screen, and so forth. The functions of the communication device 100 include, but are not limited to, establishing a communication session, sending a text message, and storing phone numbers.

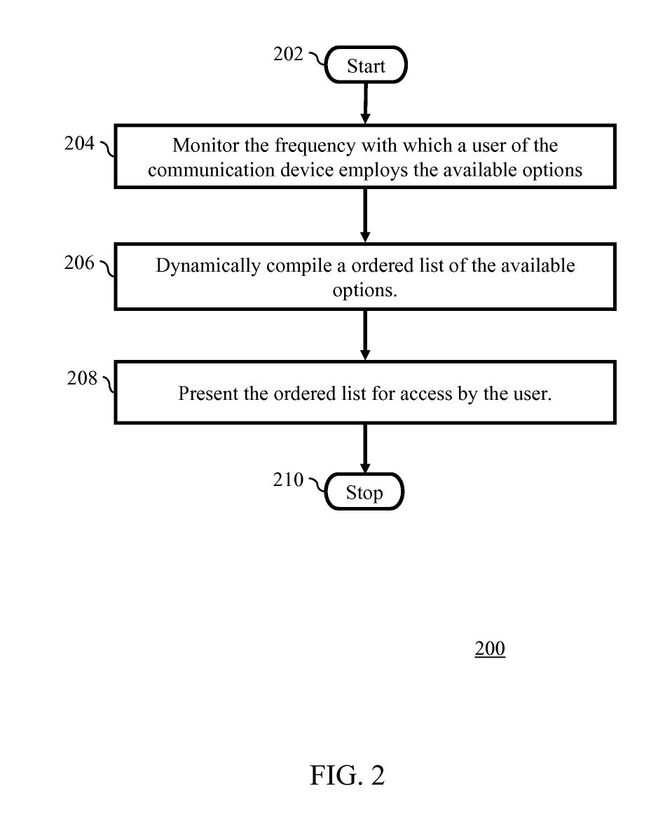

FIG. 2 is a flow diagram illustrating a method 200 for compiling and presenting an ordered list of available options for the communication device 100, in accordance with an embodiment of the present invention. The flow diagram illustrates an exemplary method to practice the invention; however, it will be apparent to a person ordinarily skilled in the art that the flow diagram can include fewer or more number of steps.

The method starts at step 202. At step 204, a frequency corresponding to the employment of the available options such as a list of contact persons, and a list of songs, is monitored. For example, a mobile phone user frequently calls up a particular phone number. The number of times he calls up the particular phone number is counted and stored as the frequency with which the user access that particular phone number. The available options are employed by a user of a communication device 100.

At step 206, the list of the available options is dynamically compiled. For example, a list of phone numbers is sorted again (if required) every time a user dials a phone number. The list of the available options is ordered from the most frequently employed to the least frequently employed. In other words, the list of phone numbers is ordered such that the phone numbers that are more frequently dialed (or accessed) appear higher in the list.

Thereafter, at step 208, the ordered list of the available options is presented to the user for access. For example, the list of phone numbers, arranged in order of frequency of usage, can be displayed to the user of the mobile phone via the LCD screen mounted in the mobile phone. Thereafter, the method terminates at step 210.

In one embodiment, the user may select whether or not method 200 is used. In this embodiment, the user selects either an alphabetical listing or the ordered listing provided by method 200.

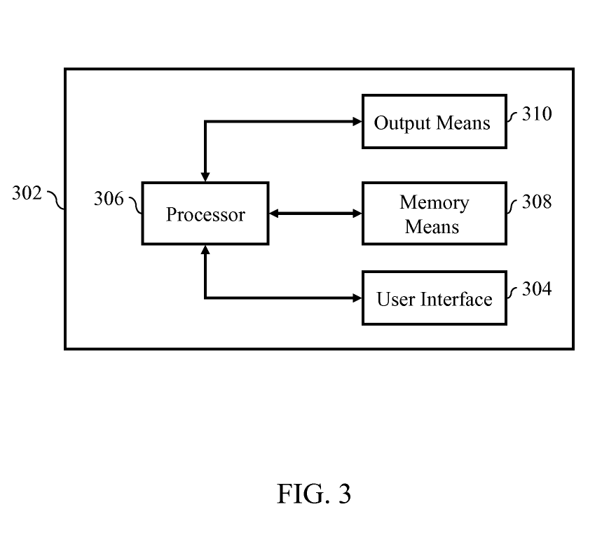

FIG. 3 is a block diagram of the communication device 100, in accordance with an embodiment of the present invention. It should be noted that various elements of the communication device 100 are shown for illustrative purpose only and the functions of the elements can be performed interchangeably. Further, the communication device 100 can include fewer or more number of elements.

The communication device 100 is adapted to compile and present an ordered list of the available options. The communication device 100 includes a user interface 304, a processor 306, a memory means 308 and an output means 310.

The user interface 304 is logically connected to the processor 306. The user interface 304 allows a user of the communication device 100 to employ available options. For example, a user can scroll through the phone book in his mobile phone. The processor 306 monitors the frequency of employment of available options. For example, the processor 306 can monitor the number of times each phone number is dialed. Further, the memory means 308 can store the ordered list of available options. The ordered list of available options is sorted based on the frequency of employment of each available option. The most frequently employed option appears at the top of the ordered list and the least frequently employed option appears at the bottom of the ordered list. Examples of the memory means 308 can be a flash memory card, a random access memory (RAM) chip, a hard disk, a solid state memory, and the like. For example, a phone book of a mobile phone can be arranged such that most frequently dialed number appears at the top of the list. Thereafter, the ordered list of available options is displayed to the user by using the output means 310. For example, the ordered phone book is displayed at the screen of a mobile phone

In an embodiment, the user interface 304 can accept a user identifier. The user identifier can be accepted by input means. Examples of the input means can be a keyboard, a joystick, a touch screen and the like. The user identifier is primarily used to identify a particular user or a group of users. For example, the entry ‘John’, with reference to FIG. 1, is associated with the contact information of a person called ‘John’. In another example, the owner of a mobile phone may need to give access to another person to use the mobile phone. The owner can set a password for another person to access the mobile phone, the password would qualify another person as a legitimate user of the mobile phone. In an embodiment the user identifier can be a password. An example of the password can be a number, a series of characters, an alphanumeric string and the like. In another embodiment the user identifier can be a biometric signature. Examples of biometric signature can be facial recognition, fingerprint recognition, iris scan and the like.

Moreover, a processing means (or the processor 306) can associate the user identifier with the ordered list of available options. It should be noted that the processing means can be a logical/physical entity that can associate the user identifier with the ordered list. Further, ‘the processor 306’ is used interchangeably with ‘the processing means’ for illustrative purpose only. For example, the processor 306 can ensure the ‘John’ always refers to the contact information of ‘John’. The ordered list is presented to the particular user or particular group of user via the output means 310. In an embodiment of the invention, the output means 310 can be a display screen displaying the ordered list of available options. Examples of a display screen include a LCD, a TFT, a plasma screen, and the like. In another embodiment of the invention, the output means 310 can be an audio transducer. Examples of the audio transducer can be a speaker, an earphone, and the like.

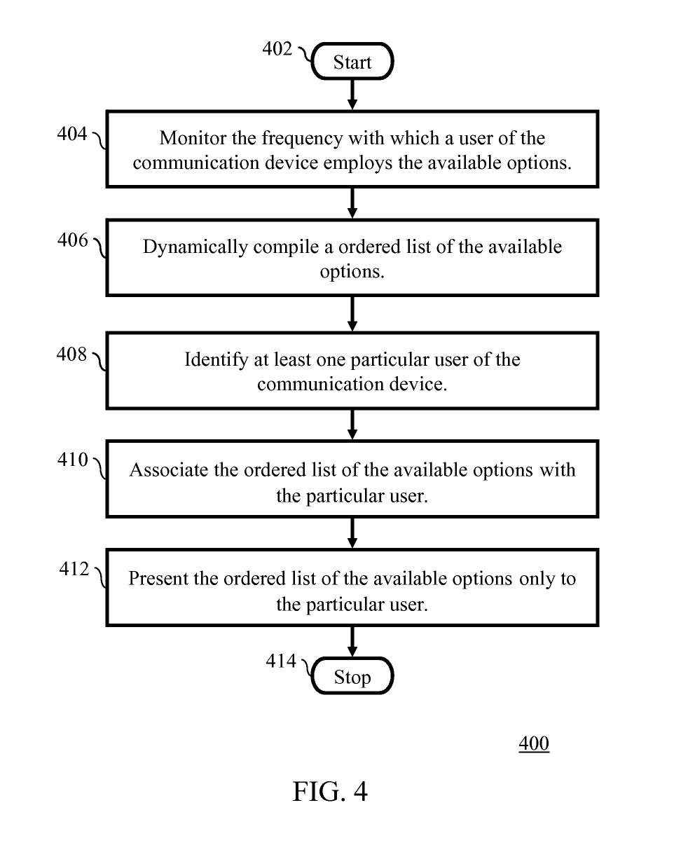

FIG. 4 is a flow diagram 400 illustrating a method for compiling and presenting an ordered list of user available options, in accordance with another embodiment of the present invention. It should be noted that the method is explained with reference to the communication device 100, however, the method can be implemented with respect to any other the communication device as well. Moreover, the method may include fewer or greater number of steps.

At step 402, the method is initiated. At step 404, the frequency of employment of available options by a user of the communication device 100 is monitored. An example of the frequency of employment of the available options can be the number of times phone numbers are dialed. At step 406, the list of the available options is dynamically compiled. Typically, the list of available options is arranged from the most frequently employed to the least frequently employed available option. An example of the ordered list can be a list of phone numbers, arranged in the order of frequency of dialing, the number that is most frequently dialed is placed at the start of the list, followed by the rest of phone numbers arranged in the descending order of the frequency of usage.

At step 408, a particular user of the communication device 100 is identified. The particular user is identified to ensure a legitimate access to the available options. Further identification of the particular user ensures that the list of available options is customized for the user. In an embodiment, the user can is identified by a password. For example, a user of a communication device is required to provide a numeric code, preset by the user, to access the phonebook of the communication device. In another embodiment, a user may also be identified based on the biometric signature such as fingerprints, retina profile, and/or voice modulation.

At step 410, the ordered list of the available options is associated with the particular user. The preferences and settings associated with the particular user are also associated with the ordered list of the available options. For example, a first user may arrange the phone book such that five most repeatedly dialed entries appears at the top of the phone book and rest of the entries appear in an alphabetical order. A second user can arrange the whole phone book based on frequency of usage. Thus, when the first user accesses the mobile phone, the phone book is arranged according to his preferences. At step 412, the ordered list of available options is presented to the particular user. In an embodiment, the ordered list can be displayed on the display screen 102. In another embodiment, the ordered list is presented by audible recitation. The audible recitation can be made through an audio transducer such as a speaker, an earphone, and the like. Thereafter, the method terminates at step 414.

Various embodiments of the method and system for displaying a set of entries have been described above. The invention enables a significant reduction in the time required to access an option (or an entry) in a communication device. The invention provides a convenient way for a user to access the available options on a communication device.

It will be appreciated that the method and system for communicating within a wireless communication system described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to manage communication sessions in a plurality of communication networks. Alternatively, some or all the functions could be implemented by a state machine that has no stored program instructions, or in one or more application-specific integrated circuits (ASICs), in which each function or some combinations of certain of the functions are implemented as custom logic. Of course, a combination of the two approaches could be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims as issued.

What is claimed is:

1. A method for compiling and presenting an ordered list of available options for a communication device, the method comprising:
monitoring a frequency with which a user of the communication device employs the available options;
dynamically compiling a list for each of the available options ordered from the most frequently employed to the least frequently employed; and
presenting the ordered list of available options for access by the user.

2. The method of claim 1 further comprising:
identifying a particular user of the communication device;
associating the ordered list of available options with the particular user; and
presenting the ordered list of available options only to the particular user.

3. The method of claim 2 wherein the particular user is identified by a password.

4. The method of claim 2 wherein the particular user is identified by a biometric signature.

5. The method of claim 1 wherein the communication device comprises one of a telephone, a personal computer, a media appliance, personal digital assistant.

6. The method of claim 1 wherein presenting the ordered list of available options for access by the user is made via a display screen.

7. The method of claim 1 wherein presenting the ordered list of available options for access by the user is made via an audible recitation.

8. A communication device adapted to compile and present an ordered list of available options, the communication device comprising:
a user interface for employing available options;
a processor for monitoring the frequency with which a user of the communication device employs the user interface to access the available options;
a memory means for storing a dynamically compiled listing for each of the available options ordered from the most frequently employed to the least frequently employed; and
an output means for communicating the ordered list of available options to the user.

9. The communication device of claim 8 further comprising:
an input means for accepting a user identifier, the identifier being associated with a particular user or particular group of users;
processing means for associating the user identifier with the ordered list of available options; and
presenting the ordered list of available options to the particular user or particular group of users via the output means.

10. The communication device of claim 9 wherein the user identifier is a password.

11. The communication device of claim 9 wherein the user identifier is a biometric signature.

12. The communication device of claim 8 wherein the communication device comprises one of a telephone, a personal computer, a media appliance, personal digital assistant.

13. The communication device of claim 8 wherein the output means for communicating the ordered list to the user is a display screen.

14. The communication device of claim 8 wherein the output means for communicating the ordered list to the user is an audio transducer.

14. A computer program product for use with a computer, the computer program code performing:
monitoring the frequency with which a user of the communication device employs the available options;
dynamically compiling a list for each of the available options ordered from the most frequently employed to the least frequently employed; and
presenting the list of available options for access by the user.

15. The computer program product of claim 14 further performing identifying a particular user of the communication device.

16. The computer program product of claim 14 further performing associating the ordered list of available options with the particular user.
